(19) United States
(12) Patent Application Publication
(10) Pub. No.: US 2017/0104711 A1
(43) Pub. Date: Apr. 13, 2017

(54) SYSTEMS AND METHODS FOR TEXT TO SOCIAL NETWORKING SITE TO BUY

(71) Applicant: Qwasi, Inc, New York, NY (US)

(72) Inventors: Lara Hanson, Hoboken, NJ (US); Jon Thies, Malvern, PA (US); Leon Samuel, New York, NY (US)

(21) Appl. No.: 15/387,020

(22) Filed: Dec. 21, 2016

Related U.S. Application Data
(63) Continuation of application No. 14/556,550, filed on Dec. 1, 2014.
(60) Provisional application No. 61/910,736, filed on Dec. 2, 2013.

(51) Int. Cl. H04L 12/58; G06Q 30/02; H04M 1/725; H04W 4/18; H04W 4/14; H04L 12/24

(52) U.S. Cl. CPC H04L 51/32; H04W 4/14; H04L 41/048; H04M 1/72561; H04M 1/72555; H04W 4/18; G06Q 30/0267; G06Q 50/01

(57) ABSTRACT

Methods and systems for publishing content received via a cellular message to a social networking server to convert visitors of the published content into customers are provided. An agent executing on a device including one or more processors receives, via a cellular communication channel, a cellular message to publish content included in the cellular message to a server of a social networking web site. The agent identifies, from the cellular message, an entity corresponding to one of a tag or address included in the cellular message. The agent identifies a uniform resource locator (URL) of the entity based on the content included in the cellular message. The agent communicates a request to publish the content included in the cellular message to the server. The request includes the URL of the entity to direct traffic from the server to a resource of the entity corresponding to the URL.

### RELATED APPLICATION

This application is a continuation of and claims the benefit of and priority to U.S. Non-Provisional application Ser. No. 14/556,550, titled “SYSTEMS AND METHODS FOR TEXT TO SOCIAL NETWORKING SITE TO BUY” and filed on Dec. 1, 2014, which claims the benefit of and priority to U.S. Provisional Application No. 61/910,736, titled “TEXT TO PIN TO BUY” and filed on Dec. 2, 2013, all of which are incorporated herein by reference in their entirety for all purposes.

### FIELD OF THE DISCLOSURE

The present application relates generally for publishing content on a server of a social networking web site via cellular messaging, and, more particularly, to improved systems and methods for publishing content received via SMS to a server of a social networking web site to convert visitors of the published content into customers.

### BACKGROUND

Nowadays, messages can be transmitted over a variety of different delivery channels. One such delivery channel is short message service (SMS). In the recent past, SMS messaging has been used as a marketing channel. Other marketing channels that have been become popular are social network platforms. These platforms include Facebook, Twitter, Pinterest, amongst others. Companies are looking for ways to increase online sales by driving existing and potentially new customers to one or more webpages of their websites.

### SUMMARY

Various embodiments disclosed herein are directed to methods and systems for publishing content received via short message service (SMS) to a social networking platform to convert visitors of the social networking platform accessing the published content into customers. In some embodiments, a client agent of a client can receive an SMS message including an image from a consumer. The SMS message can include a request to publish the image on a particular social networking platform or website. The client agent can, responsive to the request, upload the received image on a webpage. The webpage can be a webpage stored on a server of the client agent. The client agent can then send a request to the social networking platform on which to publish the uploaded image to publish the image. The image can be published in such a way that visitors accessing the image can be routed to the webpage of the client agent on which the image was uploaded. The client agent can configure the webpage in such a way so as to redirect traffic from the webpage to a webpage of the client that is related to the image. In some implementations, instead of automatically communicating with the social networking platform, the client agent can send a link to the webpage of the client agent on which the image is uploaded to the sender of the SMS message. The webpage of the client agent can include an object, just as a link or icon, through which the sender can communicate with the social networking platform to publish the uploaded content. In such implementations, the image can still be published in such a way that visitors accessing the image can be routed to the webpage of the client agent on which the image was uploaded.

In one particular example, a consumer can share a photo of a product with an intermediary entity or system acting as an agent of a company via a SMS message. The intermediary entity can intercept the SMS message, identify the image, modify the image to include a watermark (or other form of branding) and upload the modified image to a webpage of the intermediary entity. The intermediary entity can then provide the link to the webpage to the consumer via an SMS message or may automatically send a request to a social networking platform, such as Pinterest, to publish the modified image. Once the image is published on Pinterest, visitors of the published image can be redirected to the webpage on which the image was uploaded. The intermediary entity can configure the webpage on which the image was uploaded such that all traffic to the webpage is redirected to another webpage where a visitor can purchase the product shown in the image. As a result, visitors of the social networking platform can view the published image, take an action on the image, for example, click on the image, and get directed to the webpage where the visitor can purchase the product shown in the image. In some implementations, the webpage to which the visitor is directed does not necessarily have to be a page where the visitor can purchase the product shown in the image. In some implementations, the webpage to which the visitor is directed can be a general landing page associated with an advertiser advertising the product on the social network, a product information page for the product, an offer page for the product, a homepage of a website associated with the advertiser or the product itself, or any other webpage where the advertiser would like the visitor to be directed. In some implementations in which the visitor is directed to the webpage where the visitor can purchase the product shown in the image, the present disclosure enables the process of SMS-Social Network Action-Buy, such as SMS-Pin-Buy. This process entails receiving an SMS that includes a content item, pinning or publishing the content item on a social networking platform, such as Pinterest, and allowing visitors of the published content item to view the content item from the content provider and/or buy the content item in a seamless manner.

According to one aspect, systems and methods for publishing content received via an SMS message to a social networking platform to convert visitors of the published content into customers are described herein. In brief overview, the method includes receiving, by a client agent, an SMS message to publish content included in the SMS message on a social networking platform, identifying a client with which to associate the received SMS message and a social networking platform on which to publish the content, uploading the content to a webpage configurable by the client agent and facilitating the publishing of the uploaded content to the identified social networking platform.

According to another aspect, a method for publishing content received via a cellular message to a server of a social networking web site is described. An agent executing on a device including one or more processors and configured with a network interface to communicate via a cellular network receives, via a cellular communication channel, a cellular message to publish content included in the cellular message to a server of a social networking web site. The agent identifies, from the cellular message, an entity corresponding to one of a tag or address included in the cellular message. The agent identifies a uniform resource locator (URL) of the entity based on the content included in the cellular message. The agent communicates a request to publish the content included in the cellular message to the server of the social networking web site. The request to publish includes the URL of the entity to direct traffic from the server of the social networking web site to a resource of the entity corresponding to the URL.

In some implementations, the agent can upload the content included in the cellular message to the resource of the entity, the resource of the entity configurable by the agent. In some implementations, the resource of the entity is a first resource and the agent can upload the content included in the cellular message to a second resource configurable by the agent. The URL of the entity included in the request can include an address of the second resource that is linked to the first resource of the entity. In some implementations, the agent can create the second resource to which the content is uploaded responsive to receiving the cellular message.

In some implementations, the agent can identify an address of a resource of the social networking web site to which the content is published and transmit, via the cellular communication channel, to a cellular device that transmitted the cellular message, the address of the resource of the social networking web site. In some implementations, the cellular message includes an image and instructions corresponding to the image. In some implementations, the instructions include a title of the image, a description of the image, or a product identifier corresponding to a product shown in the image.

In some implementations, the tag includes a predetermined set of characters, a subset of the set of characters are unique to the entity. The agent can identify the entity based on the subset of characters.

In some implementations, the agent can identify the content included in the cellular message prior to communicating the request to publish the content to the server of the social networking web site. In some implementations, the agent can identify a product identified by the content included in the cellular message and identify a resource of the entity identified by the cellular message that corresponds to the product.

In some implementations, the resource to which the content is published includes a social networking object. The social networking object can be configured to cause a request to publish the uploaded content to the server of social networking web site to be submitted in response to receiving an action on the social networking object.

In some implementations, the content of the message can include an image captured by the consumer device via which the cellular message is transmitted to the agent. In some implementations, the cellular message can be a message transmitted by a cellular device. In some implementations, the cellular message can include an SMS message, an MMS message, an instant message, or any other message sent via an application executing on the cellular device.

According to another aspect, a system for publishing content received via a cellular message to a server of a social networking web site is described. The system includes an agent executing on a device including one or more processors and configured with a network interface to communicate via a cellular network. The agent includes a message manager and a content configuration manager. The message manager is configured to receive, via a cellular communication channel, a cellular message to publish content included in the cellular message to a server of a social networking web site. The message manager is configured to identify, from the cellular message, an entity corresponding to one of a tag or address included in the cellular message. The content configuration manager is configured to identify a uniform resource locator (URL) of the entity based on the content included in the cellular message. The content configuration manager is configured to communicate a request to publish the content included in the cellular message to the server of the social networking web site. The request to publish includes the URL of the entity to direct traffic from the server of the social networking web site to a resource of the entity corresponding to the URL.

In some implementations, the content configuration manager is configured to upload the content included in the cellular message to the resource of the entity, the resource of the entity configurable by the agent. In some implementations, the resource of the entity is a first resource and the agent can upload the content included in the cellular message to a second resource configurable by the agent. The URL of the entity included in the request can include an address of the second resource that is linked to the first resource of the entity. In some implementations, the agent can create the second resource to which the content is uploaded responsive to receiving the cellular message.

In some implementations, the content configuration manager can identify an address of a resource of the social networking web site to which the content is published and transmit, via the cellular communication channel, to a cellular device that transmitted the cellular message, the address of the resource of the social networking web site. In some implementations, the cellular message includes an image and instructions corresponding to the image. In some implementations, the instructions include a title of the image, a description of the image, or a product identifier corresponding to a product shown in the image.

In some implementations, the tag includes a predetermined set of characters, a subset of the set of characters are unique to the entity. The agent can identify the entity based on the subset of characters.

In some implementations, the content configuration manager can identify the content included in the cellular message prior to communicating the request to publish the content to the server of the social networking web site. In some implementations, the agent can identify a product identified by the content included in the cellular message and identify a resource of the entity identified by the cellular message that corresponds to the product.

### BRIEF DESCRIPTION OF THE DRAWINGS

FIG. 1A is a block diagram depicting an embodiment of a network environment comprising local devices in communication with remote devices.

FIGS. 1B-1D are block diagrams depicting embodiments of computers useful in connection with the methods and systems described herein.

FIG. 2A is a block diagram depicting an environment comprising a communication technology platform useful in connection with the methods and systems described herein.

FIG. 2B depicts a process flow associated with the communication technology platform.

FIG. 2C is a block diagram depicting an embodiment of an aggregator implementing the communication technology platform.

FIG. 3 is a block diagram illustrating a computer networked environment for publishing content received via a short message service (SMS) message to a social networking platform to convert visitors of the published content into customers.

FIGS. 4A-4G are screenshots of a consumer device depicting a sequence of actions corresponding to publishing content on a social networking platform.

FIG. 5 is a block diagram illustrating a flow of a method for publishing content received via an SMS message to a social networking platform to convert visitors of the published content into customers.

FIG. 6 is a block diagram illustrating a flow of a method for publishing content received via a cellular message to a server of a social networking web site.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes a communication platform which may be useful for practicing embodiments described herein.

Section C describes embodiments of systems and methods for publishing content received via a short message service (SMS) message to a social networking platform to convert visitors of the published content into customers.

### A. Computing and Network Environment

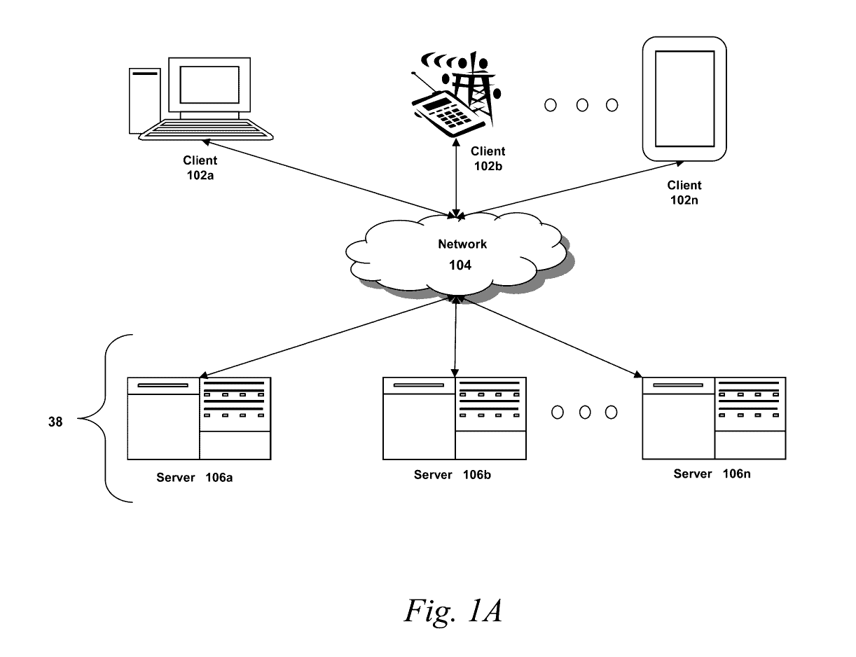

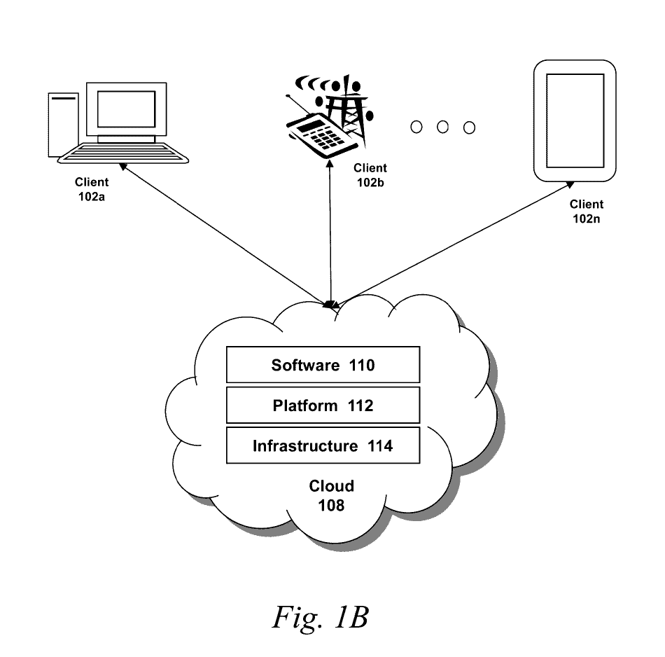

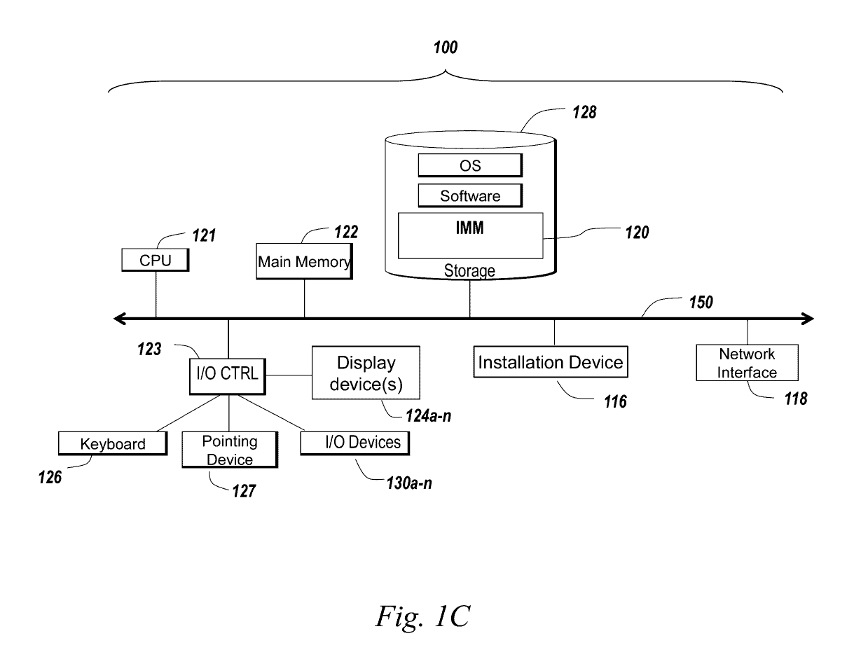

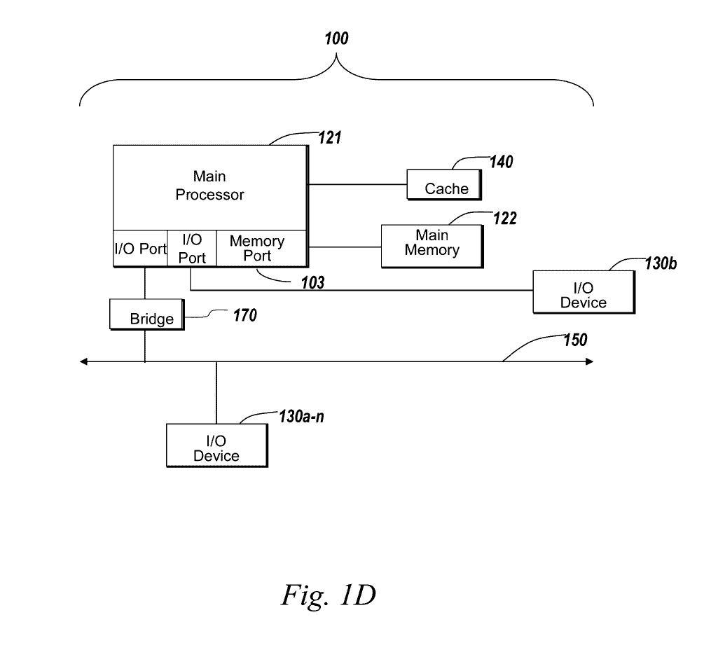

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and software of a content distribution system (CDS) 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RANI (nvSRAM), Ferroelectric RANI (FeRAM), Magnetoresistive RANI (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WIT, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the content distribution system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WIT U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Communication Technology Platform

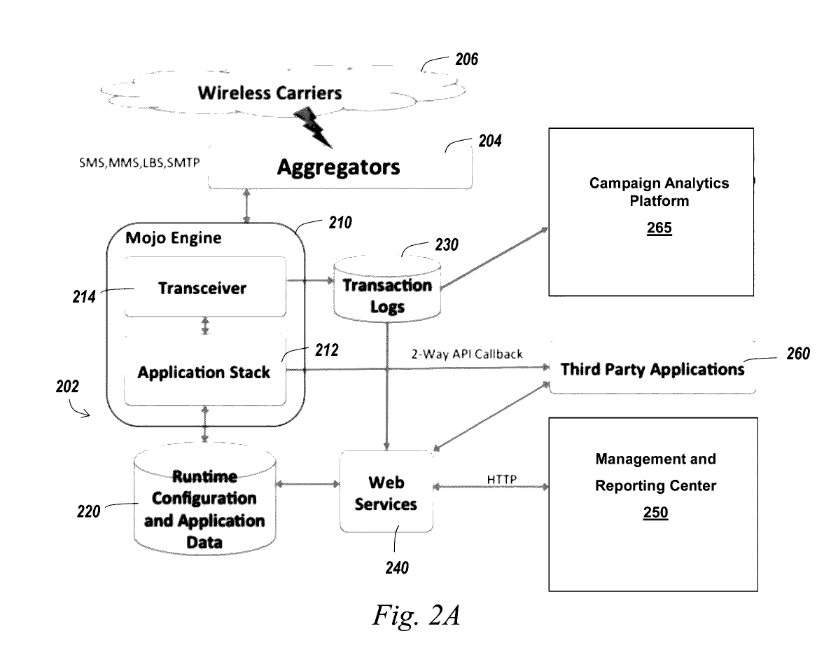

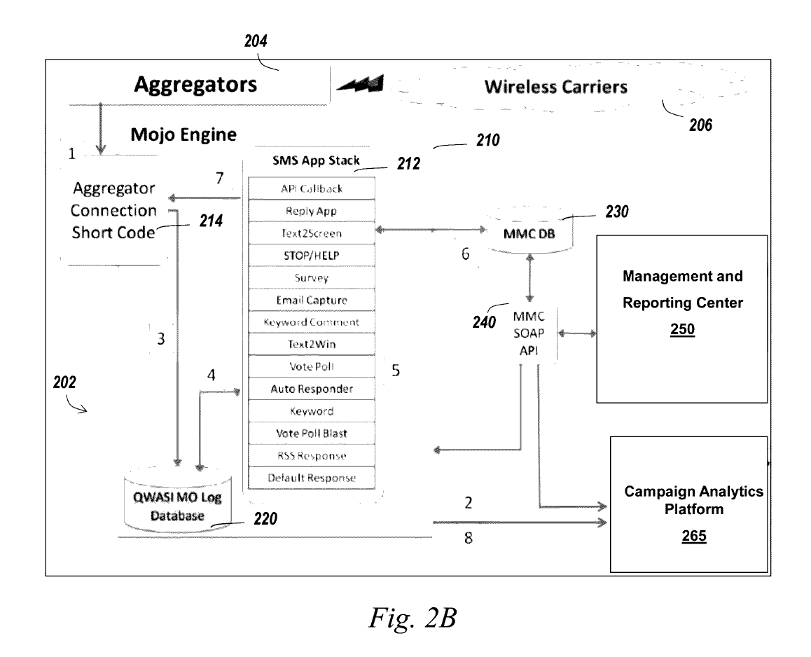

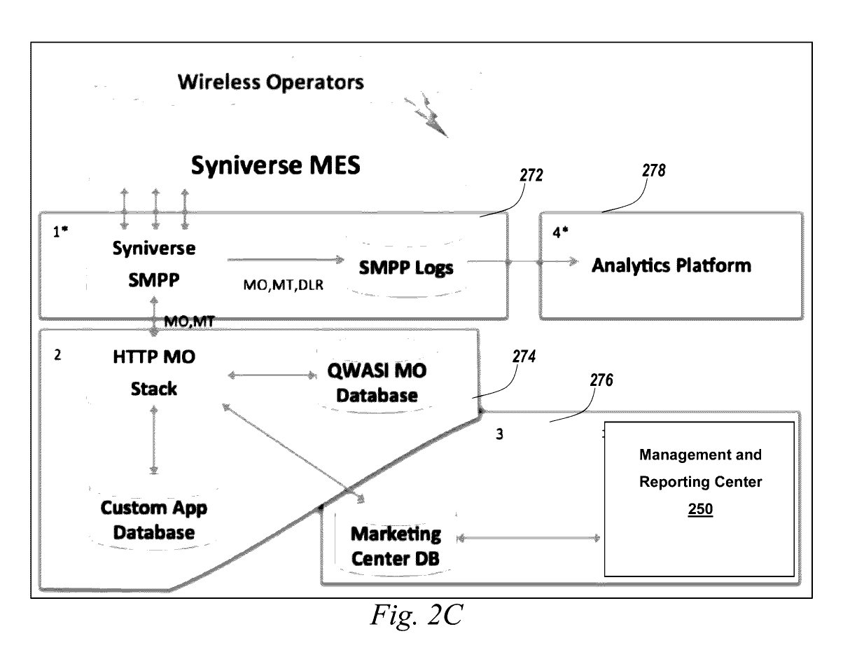

Referring now to FIG. 2A, a block diagram depicting an environment comprising a communication technology platform useful in connection with the methods and systems described herein is shown. The communication technology platform 202 facilitates the delivery of messages from a client to one or more consumers associated with the client. In particular, the communication technology platform 202 can be configured to receive via an SMPP protocol, a request from the client to send a message to one or more consumers of the client via any of a plurality of delivery channels. In some implementations, the client may be a company, business or any other entity that may wish to send messages to one or more recipients. In some implementations, the consumers may be associated with the client either as current, past or future users, members or subscribers, or through any other form of association in which the client and consumers may communicate with one another.

More generally, when a client wants to send a message to one or more consumers associated with the client, the client may use an application provider, such as the communication technology platform 202 to create a request to send out messages. The application provider can communicate with an aggregator, which in turn can communicate with one or more wireless carriers. The wireless carriers can communicate with the consumer devices associated with the consumers to whom the client would like to send messages. In some implementations, the application provider can be coupled to the aggregator.

In some implementations, a client, such as a company may utilize one or more short codes for marketing or other purposes. The short code can be assigned to a particular application, which oftentimes, is provided by the application provider used by the client.

Each message addressed to an active short code is routed to an application. Although clients can develop and host applications, there are application providers, such as the communication technology platform 202, that may specialize in software development and hosting for mobile messaging applications. Application providers can provide one or more types of applications, such as voting/polling, marketing or gaming.

To use an active short code, the client may need connectivity to the networks of participating wireless carriers, so any message addressed to the active short code can reach the application to which the short code is assigned. In some implementations, the most common method for connecting to a wireless network is Short Message Peer to Peer (SMPP) over a secured virtual private network (VPN) connection.

Aggregators typically have authorized connections to multiple wireless networks. In some implementations, aggregators also maintain the security, technical and service level requirements of each wireless network. Wireless carriers, also sometimes referred to as mobile operators, wireless networks or wireless service providers are the companies from which customers can purchase connection services for their consumer devices, for example, mobile phones.

Referring now again to FIG. 2A, in brief overview, the communication technology platform 202 can be configured to communicate with one or more aggregators 204. The aggregators 204 are configured to send and receive data packets from and to one or more wireless carriers 206. The wireless carriers 206 can communicate with one or more clients and one or more customers of the clients. In some implementations, the aggregator 204 can communicate with one or more clients and customers of the clients via the wireless carriers 206.

The communication technology platform 202 can include a flexible and efficient messaging and application framework 210, a runtime configuration database 220, a transaction database 230 that archives all transactions for analytics and reporting, a set of web services 240 to configure and access application data and a management and reporting center 250 configured to provide a simple user interface.

The communication technology platform 202 can be designed, constructed or configured as a flexible, stable, extensible, high performance platform that can handle a very wide variety of application types. In addition to marketing applications, the communication technology platform 202 may be configured to handle various message-based services. Examples of such message-based services can include feature rich mobile campaign management services, image transmission services via Multimedia Messaging Service (MMS), social applications via one or more social networks or social media applications (for example, Facebook and Twitter), text-based services for ordering products, location-based services and other third-party applications that send or receive messages (for example, online trading applications to customer relationship management (CRM) applications).

The messaging and application framework 210 may be the core of the communication technology platform 202. The framework 210 can include two discrete components—an application stack 212, which can be an efficient, configurable application management framework and a message processor 214, such as a transceiver.

The message processor 214 can be configured to parse incoming messages received by the aggregator to identify the message type, carrier, sender, short code and the message content. The application stack 212 can be configured to process the parsed message to determine which application will handle the message. The application may be internal to the application stack or related to a third party application or system. Once the application is identified and accessed, the message processor 214 can send a response, while the application stack 212 can change states to receive the next message from the same sender in a structured conversation.

The messaging and application framework 210 can handle streams of messages from multiple carriers on multiple short codes in relation to multiple applications. For every application, the messaging and application framework 210 maintains the context of each individual interaction in readiness for the next incoming message in that thread. The application stack 214 can manage a very large number of applications at very high speed without losing context. Additional details of the application stack 214 are provided below with respect to FIG. 2B.

The runtime and configuration database 220 can be designed, constructed or configured to maintain contextual data to facilitate the initiation of interactions for any application and to maintain the status of the interaction thereafter. The runtime and configuration database 220 can also be configured to include data generated by such applications.

The transaction log database 230 can be designed, constructed or configured to maintain a log of transactions handled by the messaging and application framework 210. In some implementations, there can be a deliberate separation between the runtime transaction system that the messaging and application framework 210 provides and the analytics subsystem. This is so the analytics processing on the system can be run at any time without impacting the runtime system's performance.

The web services 240 can be designed, constructed or configured to control access to the runtime and configuration database 220, to one or more third party applications 260 and to the management and reporting center 250. In this way, the web services 240 can enable third party applications 260 to access data associated with the applications within the application stack 210 and can enable the management and reporting center 250 to set application data and construct reports of the activities of the one or more applications within the application stack 210. In some implementations, the web services 240 can be a web services Application Programming Interface (API).

The management and reporting center 250 can be designed, constructed or configured as a flexible platform that enables management and reporting functions to be optimized for different application types. The management and reporting center can be configured to allow clients to build, manage and analyze mobile marketing campaigns. The management and reporting center 250 can be configured to provide several configurable options, including but not limited to branding and multi-tiered account management, reporting and billing. These options can be used in part to allow marketing service providers to easily incorporate mobile marketing services into their portfolio of customer offerings. The management and reporting center 250 can also be configured to interface with a standard two-way API for custom integration with other web services. In some implementations, the management and reporting center 250 and the web services 240 can be configured to communicate over an application layer protocol, for example, HTTP or HTTPS.

One of the common applications of the communication technology platform 202 is in the context of a mobile marketing campaign (MMC), in which the communication technology platform 202 allows for management and reporting of mobile campaigns. FIG. 2B depicts a process flow associated with a mobile marketing campaign managed by the communication technology platform. In brief overview, the communication technology platform 202 can exchange messages with clients and customers of the clients via the aggregator 204, which communicates with the clients and customers via the wireless carriers.

The communication technology platform 202 can include the messaging and application framework 210, the runtime configuration database 220 shown as a mobile originated log database, the transaction database 230 shown as the mobile marketing campaign (MMC) database, a set of web services 240 shown as a mobile marketing campaign Simple Object Access Protocol (SOAP) API, and the management and reporting center 250 shown as a mobile marketing center.

In some implementations, campaign information can stored in the MMC database 230 using the MMC SOAP API 240. In some implementations, clients can choose to use an MMC Graphical User Interface (GUI) or programmatically configure the campaigns using APIs within their own managed applications.

A basic flow for a mobile marketing campaign, for example, an SMS campaign, handled by the communication technology platform 202 can be summarized in accordance with a series of steps shown in FIG. 2B. As depicted in step 1 of FIG. 2B, the messaging and application framework 210 receives a MO (Mobile Originated) message from a wireless carrier 206 via the aggregator 204. The message includes information associated with the sender, recipient (for example, a short code associated with the recipient), carrier, message body, and message type (for example, SMS, MMS, LB S). As depicted in step 2 of FIG. 2B, the messaging and application framework 210 can be configured to log the raw MO content in the into a campaign analytics platform 265 of the messaging and application framework 210. As depicted in step 3 of FIG. 2B, the messaging and application framework 210 requests and retrieves any previous application context information associated with the sender and recipient from the runtime and configuration database 220.

As depicted in step 4 of FIG. 2B, the application stack 212 receives information associated with the message and reviews the message body. In some implementations, the information associated with the message is stored in the runtime and configuration database 220. In some implementations, each application in the application stack 212 may be given the opportunity to review the message body and determine if it should be that application to handle the message. Examples of applications include an API callback application, a reply application, a text2screen application, a STOP/HELP application, a survey application, an email capture application, a keyword comment application, a text2win application, a vote poll application, an auto responder application, a keyword application, a vote poll blast application, an RSS response application and a default application amongst others. As depicted in step 5 of FIG. 2B, one or more of the applications in the application stack 212 handle or process the message.

As depicted in step 6 of FIG. 2B, the MMC database 230 can determine additional application data and log context data generated by the one or more applications handling the message. As depicted in step 7 of FIG. 2B, the application stack 212 generates a reply to the MO message received by the messaging and application framework 210 and transmits the reply as a mobile terminated (MT) message via the aggregator 204. The messaging and application framework 210 logs the MT message along with any additional meta-data added to the MT by the application stack 212 in the campaign analytics platform 260 of the messaging and application framework 210 and the runtime and configuration database 220. FIG. 2C is a block diagram depicting an embodiment of an aggregator implementing the communication technology platform. The hardware architecture 270 comprises one or more servers for each client-application provider combination. In general, clients may have more than one server to enable the required level of throughput, performance and security. FIG. 2C shows a typical configuration for a very large volume client. In some implementations, the hardware architecture can be performed on a single server. In some implementations, the hardware architecture can be performed on more than one server. For example, in the implementation depicted in FIG. 2C, four separate servers are configured to form a part of the hardware architecture.

The first server 272 can be configured to handle the Short Message Peer-to-Peer (SMPP) protocol interface and log all the traffic for data analysis by the analytics platform. The traffic includes Mobile Originated (MO) messages, Mobile Terminated (MT) messages and Delivery Report (DLR) messages. The second server 274 can be configured to handle the MO stack and application databases. The second server 274 can be load balanced as needed for high volume. Although the custom app database is shown to reside on the second server, in some implementations, it may reside on the third server. The third server 276 includes a marketing center database and a mobile campaign manager, for example, the MMC or management and reporting center 250 as shown in FIG. 2B. The fourth server 278 can be configured to include the analytics platform 265.

C. Systems and Methods for Publishing Content Received Via a Short Message Service (SMS) Message to a Social Networking Platform to Convert Visitors of the Published Content into Customers

Various embodiments disclosed herein are directed to methods and systems for publishing content received via a cellular message, such as a short message service (SMS) or multimedia message service (MMS) to a server of a social networking web site to convert visitors of the published content into customers. In some embodiments, a client agent of a client can receive content from a consumer, configure the received content to be associated with a client, provide the configured content to one or more social networking platforms such that visitors of the social networking platform can be converted into customers of the client upon taking an action on the configured content. The client agent can be an intermediary device or system that serves as an agent of the client. In one particular example, a consumer can share a photo of a product with an agent of a company via SMS with instructions to upload the photo to a social networking platform, for example, Pinterest. The agent of the company can receive the image, modify the image to include a watermark or other branding information associated with the company and/or to associate a webpage address of the company to the image. The agent can then provide the modified image to Pinterest. Upon providing the image to Pinterest, the agent provides a link to the uploaded image on Pinterest to the consumer. The consumer, upon accessing the link can visit the webpage, provide details relating to the image, for example, tag the image or add a caption for the image. In addition, the consumer can take one or more actions relating to the image, for example, pinning the image to a particular board. The pinned image can then be accessed by social networking visitors. In some implementations, the social networking visitors can be redirected to the webpage address with which the agent associated with image. In some implementations, the webpage address can correspond to a webpage where a product shown in the image can be purchased. In this way, an image received via an SMS message can be used to create a social networking marketing content item to drive traffic to a particular webpage and to convert social networking platform visitors into customers of the company.

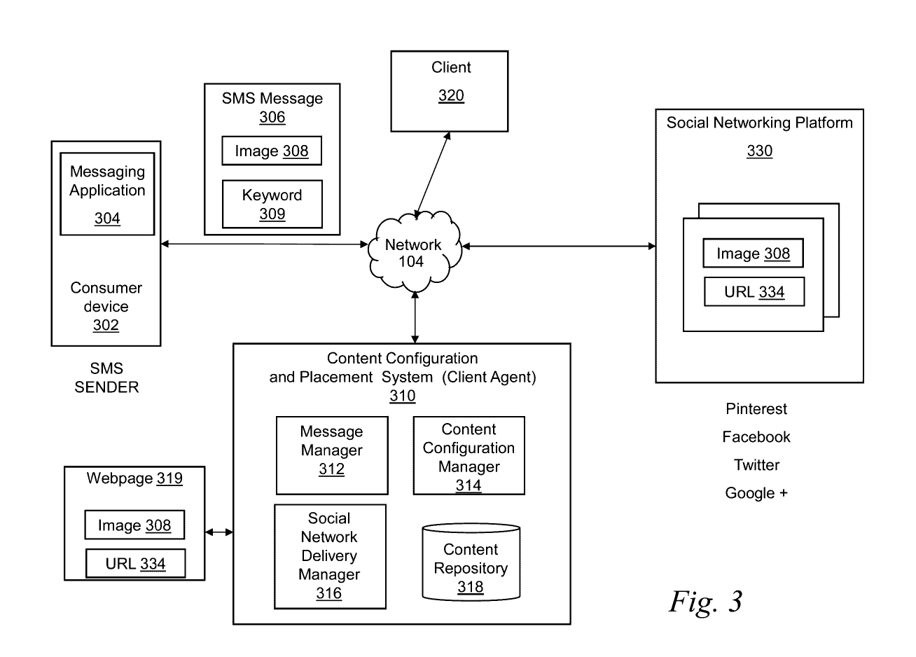

FIG. 3 is a block diagram illustrating a computer networked environment for publishing content received via a cellular message to a server of a social networking web site. In some implementations, the computer networked environment can be configured to publish content received via a short message service (SMS) message or a multimedia message service (MMS) to a server of a social networking web site to convert visitors of the published content into customers. The environment includes one or more consumer devices 302 associated with one or more consumers, an agent 310 serving as an intermediary between the consumers and a client 320 and one or more social networking platforms 330. One or more of the consumer devices 302, the client agent 310, the client 320 and the social networking platforms 330 can be configured to communicate over one or more networks, such as the network 104. In some implementations, the agent 310 can serve as an agent of one or more clients, including the client 320.

The consumer device 302 may comprise one or more applications, programs, libraries, services, processes, scripts, tasks or any type and form of executable instructions executing on one or more devices, and can be designed, constructed or configured to communicate with one or more of the client agent 310, the client 320 and the social networking platforms 330. A consumer can be an individual or entity associated with the consumer device 340. The consumer can communicate with one or more of the client agent 310, the client 320 and the social networking platforms 330 through the consumer device 302. In some implementations, the consumer can have a particular relationship with the client. For example, the consumer can be an existing or potential customer of the client or current or potential user of the client's services, amongst others. In some implementations, the consumer can be a representative, employee, contractor, endorser or supporter of the client.

The consumer device 302 can be configured to receive messages via a messaging application 304 operating on the consumer device 340. In some implementations, the messaging application 304 can be a cellular messaging application, for example, an SMS messaging application, or an instant messaging application, or any other application configured to receive messages from the client agent or send messages to the client agent. In addition, the consumer device 302 can include one or more additional applications through which the consumer device 302 can communicate with other entities, such as one or more social networking applications corresponding to one or more social networking platforms, a web browser configured to provide web services to the consumer device, amongst others. In some implementations, the consumer device 302 can include one or more multimedia applications, including an image capturing application configured to capture images, an image viewing application for viewing images, amongst others. The consumer device 302 can also include one or more cameras for capturing images and a data store for storing captured images, amongst others.

The client agent 310 can be a content configuration and placement system that is configured to receive content from a consumer device, configure the received content and provide the configured content to one or more social networking platforms 330. The content configuration and placement system 310 can be configured to seamlessly and transparently configure content in such a way so as to associate the content with a client for which the content configuration and placement system 310 can serve as an agent and provide the modified content to one or more servers of social networking web sites.

In some implementations, the client agent 310 can be a standalone entity intermediary to the client 320 and the consumer devices 302. In some implementations, the client agent 310 can operate on the client 310. In some implementations, the client agent 310 can operate on an entity intermediary to the client and the consumers, for example, on an aggregator, such as the aggregator 204 shown in FIGS. 2A and 2B. The content configuration and placement system 310 may execute on one or more servers, such as the server 106 shown in FIG. 1A.

The content configuration and placement system 310, and any modules or components thereof, may comprise one or more applications, programs, libraries, services, processes, scripts, tasks or any type and form of executable instructions executing on one or more devices, such as servers. The content configuration and placement system 310, and any modules or components thereof, may use any type and form of database for storage and retrieval of data. The content configuration and placement system 310 may comprise function, logic and operations to perform any of the methods described herein.

The content configuration and placement system 310 can include a message manager 312, a content configuration manager 314, a social network delivery manager 316 and one or more content repositories 318. The message delivery system 320 can also include one or more additional modules configured to provide additional functionality, for example, a client communication module configured to allow a client to communicate with the client agent, amongst others.

The message manager 312 may comprise one or more applications, programs, libraries, services, processes, scripts, tasks or any type and form of executable instructions executing on one or more devices, and can be designed, constructed or configured to manage one or more cellular messages, such as SMS messages 306 received from one or more consumer devices. In some implementations, the SMS messages 306 may be sent from the consumer device 302 to an address, for example, a phone number or short code, assigned to the content configuration and placement system 310. The SMS messages 306 may be destined to a client, such as client 320, for which the content configuration and placement system 310 can serve as an agent of the client. In some implementations, the message manager 312 can intercept messages intended for the client that correspond to a particular short code or phone number assigned to the client.

The message manager 312 can be configured to receive an SMS message 306 including content, for example, multimedia content. In some implementations, the message manager 312 can receive multiple SMS messages 306 from a single SMS sender and can be configured to treat the multiple SMS messages as a single request. In some implementations, the SMS messge 306 received from a cellular device of an SMS sender can include an image 308 and one or more keywords. In some implementations, the image 308 can be captured by the cellular device that sent the SMS message 306. In some implementations, the SMS sender can be configured to take a photo through the consumer device 302 associated with the SMS sender, send an SMS message 306 including the photo to a phone number or short code associated with a particular client 320 or client agent 310, and one or more text keywords.

In some implementations, the SMS message 306 received from an SMS sender can also include one or more keywords 309. In some implementations, the keywords 309 can correspond to a request to publish the image to a social networking platform, for example, Facebook, Twitter, Pinterest, Google+, amongst others. In some implementations, the keywords can include a set of characters. A subset of the set of characters can correspond to a client to which to associate the content of the SMS message. Another subset of the set of characters can identify a social networking web site to which to publish the content. One or more of the keywords 309 can identify one or more pieces of information, including an identity of a client 320 associated with the client agent 310, an identity of a social networking platform 330 to which to publish the image 308, amongst others. In some implementations, the keywords 309 can also identify an address of a webpage to which to link the image 308 when publishing the image on the social networking platform 330. In some implementations, the keywords can include instructions for the client agent 310. An example of a keyword 309 can be “Qpin,” can indicate to the client agent 310 receiving the SMS message 306 that the image 308 is to be published on Pinterest for a client 320 corresponding to the letter Q, for example, QVC. In another example, the keyword 309 can be “Qface,” which can indicate to the client agent 310 receiving the SMS message 306 that the image 308 is to be published to Facebook for the client QVC. In another example, the keyword can be “Pradapin,” which can indicate to the client agent receiving the SMS message that the photo is to be published to Pinterest for the client Prada. In some implementations, the SMS sender may be made aware of the keyword to insert for uploading content through some other external channel. In some implementations, the keyword 309 can be a collection of characters, which the message manager 312 can decipher to identify the client 320 with which to associate the SMS message 306, the social networking platform 330 on which to publish the image 308, amongst others.

In some implementations, the SMS message 306 can include a product name or identifier. For example, an SMS message 306 can include an image 308 of a Prada purse, the keyword 309 “Qpin” and a product identifier “Prada purse Model 123.” In some implementations, the message manager 312 can receive such an SMS message, identify “Prada purse Model 123” as the product identifier and perform a query to identify a webpage corresponding to the Prada purse Model 123 product. The client agent 310 can use the identified webpage as a destination webpage of the image of the Prada purse when the image is published on the social networking platform Pinterest.

The content configuration manager 314 may comprise one or more applications, programs, libraries, services, processes, scripts, tasks or any type and form of executable instructions executing on one or more devices, and can be designed, constructed or configured to upload the content, such as the image 308, of the received SMS message 306 to a web page 319. In some implementations, the content configuration manager 314 can be configured to upload the received content to a web page 319 of a server of the client agent 310. In some implementations, the content configuration manager 314 can be configured to upload the received content to a web page 319 of a server of the client 320 for which the client agent 310 is serving as an agent.

In some implementations, the content configuration manager 314 can be configured to modify the content (image 308) prior to uploading the image on to a webpage, such as the webpage 319. In some implementations, the content configuration manager 314 can be configured to improve the image quality of the image 308, insert watermarks to the image 308, embed links, amongst others. In some implementations, the content can be modified in such a manner that the content can serve as an advertisement. In one example in which the content is an image, the content configuration manager 314 can be configured to modify the received image to include any type of mark, symbol, icon, text or graphical object to associate a brand to the image such that the modified image can serve as an advertisement or promotion for the brand. In some implementations, the received image can be modified to include one or more of a name of the product, a name of the company that manufactures the product, a retail price of the product, a current price of the product, or one or more special promotions associated with the product, amongst others. In some implementations, the received image can be modified to include any type of mark, symbol, icon, text or graphical object to discourage others from using or reproducing the image. In some implementations, the received image can be modified to include any type of mark, symbol, icon, text or graphical object to provide an attribution to the person sending, capturing or creating the received image. In some implementations, the content configuration manager 314 can be configured to include skins, add or change colors of the content, insert headers, footers, borders, hot spots, animations, word art, and text, amongst others.

In some implementations, the content configuration manager 314 can be configured to modify the image according to an image modification policy specific to a particular company for which the client agent is serving as an agent. For example, a particular company may choose to insert a border around each image and insert a logo of the company at the bottom right corner of each image. By modifying every image according to the image modification policy of the company, the content configuration manager can convert images received from a plurality of sources into image advertisements or content items that have the same general look and feel, thereby giving the impression that the modified image advertisements or content items are part of a branding campaign of the company. In some implementations, the image modification policy can include one or more rules for modifying images. These rules can be based on the contents of the image, attributes of the image, for example, the size and resolution of the image, and the sender of the image, amongst others. In some implementations, images received by the message manager have to meet certain requirements before the content configuration manager 314 can modify the image. For example, the images received have to be of a minimum resolution and size, amongst others.

In some implementations, the content configuration manager 314 can be configured to promote a company for which the client agent is serving as an agent by including information associated with the company to the image. For example, the client agent can include a logo or other branding information on the image such that viewers of the modified image can associate the image and the contents of the image to the company identified by the branding information included on the image. In some implementations, the content configuration manager 314 can be configured to remove or cover existing content of the image. In some implementations, the content configuration manager 314 can be configured to insert a watermark, logo or other branding information on the image in such a manner so as to conceal existing content of the image that the client agent does not want viewers of the modified image to see.

In some implementations, the content configuration manager 314 can modify the image to also include additional content associated with the contents of the image. For example, the content configuration manager 314 can display user reviews or ratings for the contents (for example, a product) shown in the image. In some implementations, the content configuration manager 314 can retrieve the user reviews or ratings from one or more third-party providers that aggregate user reviews and ratings for products.

In some implementations, the content configuration manager 314 may be configured to identify aspects of the content to determine a profile of the object in the content. The content configuration manager 314 can then access a database that includes a plurality of images corresponding to the object in the content and use an image from the database to upload to the web page or the social networking web site. In some implementations, the database may include high quality images or images for which the agent has licensed rights (such as copyrights) to use.

In some implementations, the content configuration manager 314 can be configured to manage the webpage 319 on which the content is uploaded. In some implementations, the content configuration manager 314 can be configured to modify the webpage 319 to include additional content related to the uploaded content 308. In some implementations, the content configuration manager 314 can also be configured to modify the webpage 319 to include additional content through which a product shown in or associated with the image can be purchased. For example, if the uploaded content is an image of a tennis racket, the content configuration manager 314 can be configured to include on the web page 319, additional content regarding the tennis racket, for example, a product description of the tennis racket, a link to a webpage where the tennis racket can be purchased, amongst others. In some implementations, the webpage 319 can include content through which a visitor of the webpage 319 can purchase the tennis racket without leaving the webpage 319.

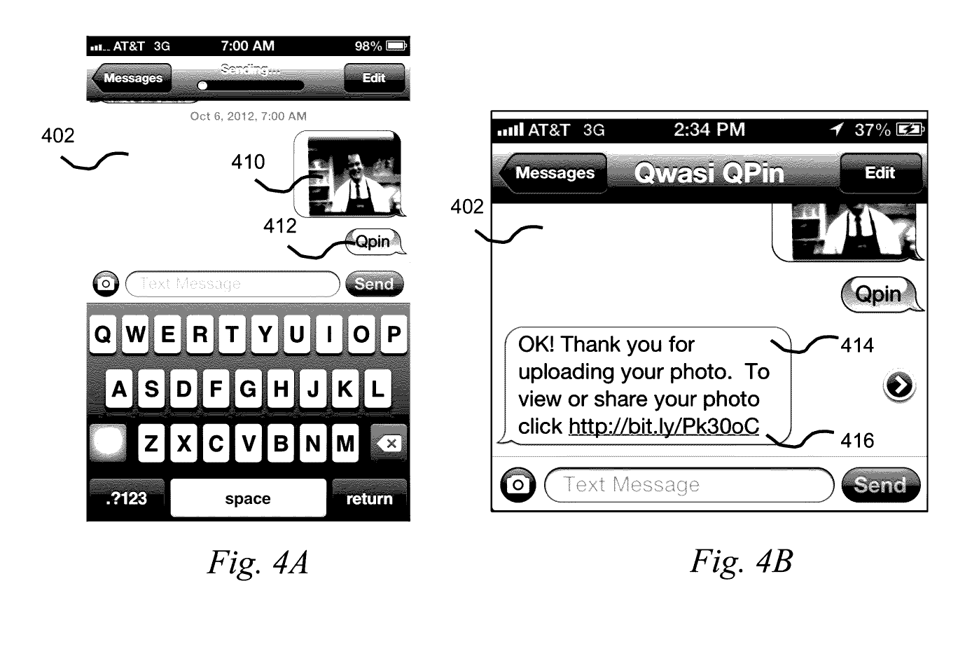

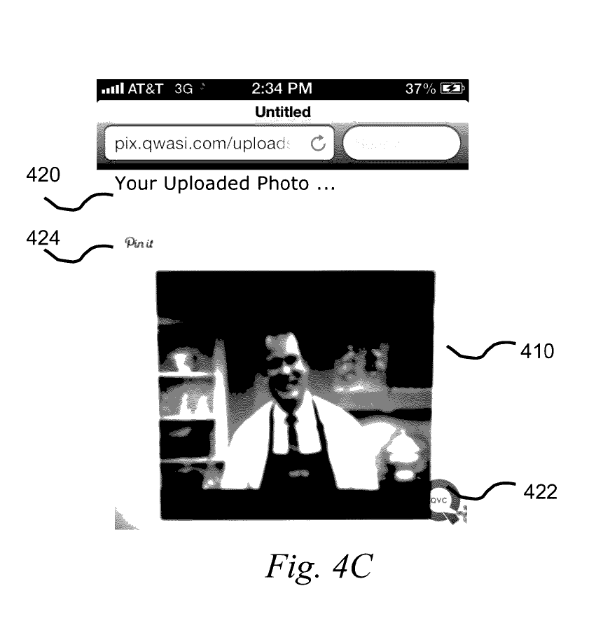

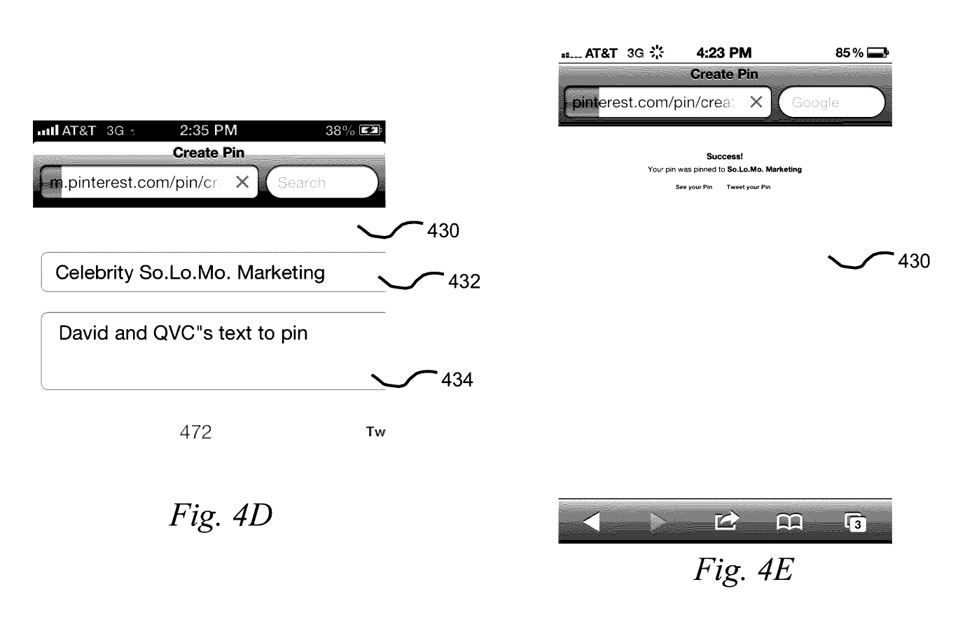

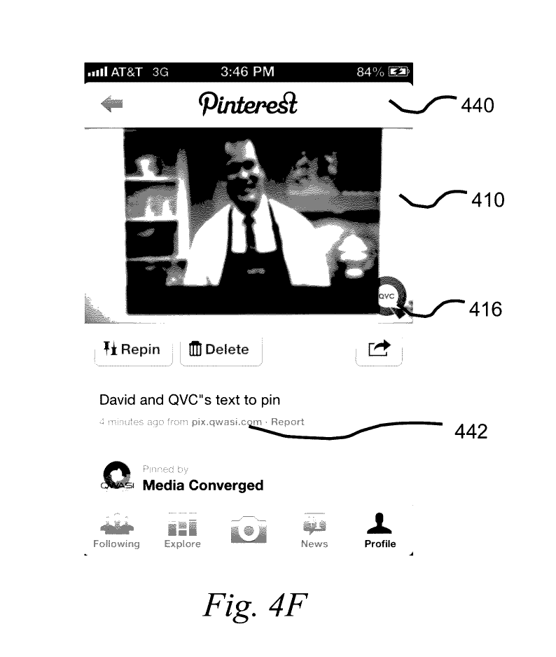

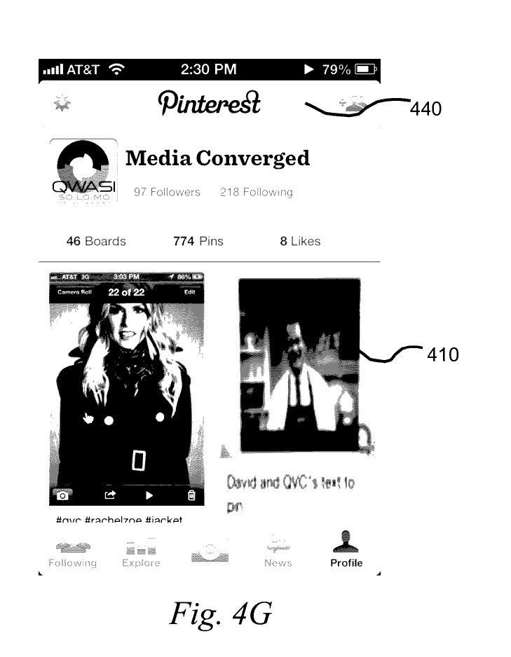

In some implementations, the content configuration manager 314 can further be configured to include one or more social networking platform icons on the webpage 319. These icons can be linked to corresponding social networking platform functionality such that when the icon is selected, the uploaded content 308 can be directed to the social networking platform 330 where the content 308 can be published. For example, as shown in FIG. 4C, the webpage can include an icon of the social networking platform, Pinterest. In some implementations, the content configuration manager 314 can include a social networking platform icon responsive to the SMS message 306 received along with the content from the consumer device. The SMS message 306 can identify the social networking platform 320 on which to publish the content 308. The content configuration manager 314 can then select an icon, link or other graphical object for insertion onto the webpage 319 through which the content 308 can be published on the identified social networking platform 320.

In some implementations, upon the content configuration manager 314 uploading the image 308 on the webpage 319, the content configuration manager 314 can send back to the consumer device 302, a response to the SMS message 306 with a link identifying a URL 334 of the webpage 319. Upon the link being accessed, the webpage 319 on which the content 308 is uploaded is provided for display on the consumer device 302. As described herein, the webpage 319 can include additional content, including an icon corresponding to a social networking platform 320 on which to publish the image 308.

In some implementations, the content configuration manager 314 can be configured to modify the webpage 319 on which the content 308 is uploaded such that the webpage 319 is linked to a webpage of a client in such a manner that traffic to the webpage 319 is redirected to another webpage. In some implementations, the webpage to which the traffic is redirected can be a webpage of the client identified by the SMS message 306. In some implementations, the URL 334 of the webpage 319 can be mapped to another webpage such that any traffic directed towards the webpage 319 on which the content 308 is uploaded is redirected to the other webpage. In this way, the URL 334 of the webpage 319 can serve as a referral link. In some implementations, the webpage 319 can be linked to another webpage in such a manner that any traffic being redirected by the webpage 319 on which the image 308 is uploaded can be identified for tracking traffic history, referral statistics, or conversions, amongst others. In some such implementations in which the webpage 319 is linked to a webpage of a client identified in the SMS message 306, a visitor that is redirected to the webpage of the client can be converted into a customer of the client upon making a purchase, signing up for a mailing list, registering an account, or taking any other action that the client has defined as a conversion.

In some implementations, the webpage to which the visitor is redirected can be a webpage where the visitor can buy the contents of the image, for example, a product shown in the image. However, in some implementations, the webpage to which the visitor is redirected can be a landing page associated with the manufacturer of the product, a retailer of the product or the advertiser associated with the published image. In some implementations, the webpage to which the visitor is redirected can be a product description page, an advertisement for the product, a page revealing a special offer or discount code for the product, a shopping cart with the product added to the card, a webpage containing a wish list of the visitor, a webpage showing reviews of the product, amongst others.

In some implementations, the content configuration manager 314 can modify the webpage 319 on which the content 308 is uploaded after the content 308 is published on a social networking platform. In this way, when a visitor of the social networking platform accesses the published content 308, the contents of the webpage that the visitor is shown is different from the contents of the webpage 319 on which the content 308 was uploaded.

The social network delivery manager 316 may comprise one or more applications, programs, libraries, services, processes, scripts, tasks or any type and form of executable instructions executing on one or more devices, and can be designed, constructed or configured to send a request to a social networking platform 330 on which to publish the content 308 included in the SMS message 306 received by the client agent 310. In some implementations, the social network delivery manager 316 can automatically submit a request to the social networking platform 330 via an API call. In some implementations, the request can include the content 308 to be published and one or more of a URL 334 with which to associate the content 308, a title of the content 308, a description of the content 308 and a social networking construct on which to display the published content 308, amongst others. Examples of social networking constructs include Pinterest boards, Facebook walls, Google+ circles, amongst others. In some implementations, the content 308 to be published can be automatically associated with the webpage 319 and the URL 334 of the webpage 319. In some such implementations, the content configuration manager 314 can be configured to update the webpage 319 on which the image 308 was uploaded by the content configuration manager 314 to include additional or different content after the image 308 has been published to the social networking platform 330. In some implementations, the content configuration manager 314 can be configured to redirect the URL 334 of the webpage 319 to a URL of the webpage to which the client agent 310 would like to direct traffic from the published image 308 of the social networking platform 330.

The client agent 310 may be designed, constructed and/or configured to communicate with and/or interface to a plurality of different content repositories 318. In some embodiments, the client agent 310 can communicate with the content repositories 318 over one or more networks 104, such as to a remote server or cloud storage service. Content repositories 318 may include any type and form of storage or storage service for storing data such as digital content. Examples of such content repositories include servers or services provided by Dropbox, Box.com, Google, amongst others. In some embodiments, the content repositories are maintained by the client agent 310. In some embodiments, the content repositories 318 are located local to the client agent 310.

In some implementations, the content repositories 318 can store content, including information associated with one or more clients and one or more consumers. A content repository, for example, a client content repository can include information associated with one or more clients, including client information, a consumer list of the client, client preferences, one or more social networking platform policies, as well as a record of any messages received from consumers of the clients.

The client 320 may comprise one or more applications, programs, libraries, services, processes, scripts, tasks or any type and form of executable instructions executing on one or more devices, and can be designed, constructed or configured to communicate with the client agent 310. In some implementations, the client agent 310 can be a service provider for the client 320 and can, for example, manage and maintain one or more marketing and advertising campaigns for the client 320. In some implementations, the client 320 can be configured to maintain one or more webpages to which traffic from a published content item, such as the image 308 on the social networking platform 330 can be directed. In some implementations, the webpages can be substantively related to the image. For example, if the image is of a tennis racket, the webpage can be one where the particular tennis racket can be bought.

The social networking platform 330 may comprise one or more applications, programs, libraries, services, processes, scripts, tasks or any type and form of executable instructions executing on one or more devices, and can be designed, constructed or configured to maintain a social network. In some implementations, the social networking platform 330 can include a social networking website, for example, Facebook, Pinterest, Twitter, Google+, amongst others. In some implementations, the social networking platform 330 can be configured to interface with the client agent 310 or one or more consumer devices 302. In some implementations, the consumer devices 302 can be configured to communicate with the social networking platform 330 to publish a content item uploaded to a server by the client agent 310. In some implementations, the client agent 310 can be configured to communicate with the social networking platform 330 to publish a content item uploaded to a server by the client agent 310. In some implementations, the social networking platform 330 can be configured to direct visitors of the social networking platform to a webpage associated with the published content, where visitors can be converted into customers of a client, such as the client 320.

FIGS. 4A-4G are screenshots of a consumer device depicting a sequence of actions corresponding to publishing content on a social networking platform. FIG. 4A is a screenshot of a user interface 402 of a messaging service of a consumer device illustrating one or more SMS message requests that includes a content item 410 (for example, an image) to be published on a social networking platform and a text string 412 corresponding to an identity of a social networking platform on which to publish the content item. As shown, the text string is “Qpin,” which can be interpreted by the client agent receiving the SMS message as instructions to post the content item 410 on the social networking platform, Pinterest. The SMS message can be sent to a destination address, for example, a phone number or short code corresponding to a particular client. In some implementations, the text string included in the SMS message can identify a client with which to associate the content item 410.

FIG. 4B is a screenshot of the user interface 402 of the messaging service of the consumer device depicting an SMS response 414 from the client agent. As shown in FIG. 4B, the SMS response 414 includes a link 416 corresponding to a webpage of the client agent that includes the image received from the SMS message sender.

FIG. 4C is a screenshot of a user interface 420 of a web browser application of the consumer device. The webpage displayed in the web browser application includes a modified version of the image 410 received from the SMS message sender. The modified version of the image 410 includes a watermark 422. In addition, the webpage includes an icon 424 corresponding to the social networking platform identified from the text string 412 of FIG. 4A. The icon 424, when accessed, can establish a communication between the consumer device and the social networking platform on which to publish the content item.

FIG. 4D is a screenshot of the user interface 430 of a web browser application of the consumer device. The webpage displayed corresponds to the social networking platform associated with the icon 424 on FIG. 4C. In response to accessing the icon 424, the consumer device is presented with the user interface 430 specific to the social networking platform whose icon was accessed. The user interface 430 includes a board field 432 in which a consumer can identify a board on which to pin the image and a description field 434 in which the consumer can provide a description of the image.

FIG. 4E is a screenshot of the user interface 430 of a web browser application of the consumer device showing a webpage generated responsive to successfully pinning the image on the board identified in the board field 432 shown in FIG. 4D. FIG. 4F is a screenshot of a user interface 440 of a native application operating of the consumer device dedicated to the social networking platform Pinterest. As shown, the image 410 along with the watermark 416 is shown. In addition, the URL 442 of the webpage from where the image 410 is uploaded is identified as well as the description provided in the description field 434 in FIG. 4D.

FIG. 4G is a screenshot of a user interface 440 of a native application dedicated to the social networking platform Pinterest that is operating on a consumer device. As shown, the image 410 is shown alongside one or more additional images that are all associated with a particular profile “Media Converged.” The profile can correspond to a profile of a marketing campaign for a particular client. In some implementations, pins created responsive to SMS messages from multiple consumers for a particular client can be associated with a particular profile. In some implementations, a consumer of the consumer device can select the image 410 shown in the user interface 440. Responsive to doing so, a web browser of the consumer device can be launched and can be directed to the webpage to which the image is linked or associated. In some implementations, the image can be linked to the webpage of the client agent on which the image was uploaded responsive to the client agent receiving the SMS message. In some implementations, the client agent may have modified the webpage such that the web browser is routed to another webpage. In some implementations, the webpage to which the web browser is directed to can be a webpage where the consumer can make a purchase, signup for a mailing list, register an account, amongst others.

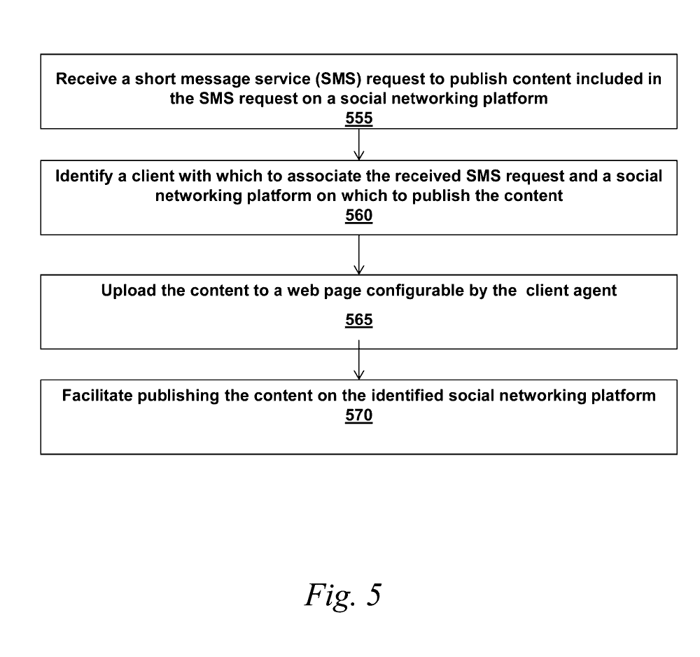

FIG. 5 is a block diagram illustrating a flow of a method for publishing content received via an SMS message to a social networking platform to convert visitors of the published content into customers. In brief overview, the method includes receiving, by an agent, a short message service (SMS) request to publish content included in the SMS message on a social networking platform (step 555), identifying a client with which to associate the received SMS message and a social networking platform on which to publish the content (step 560), uploading the content to a webpage configurable by the agent (step 565) and facilitating the publishing of the uploaded content to the identified social networking platform (step 570).

In further detail, a agent receives a short message service (SMS) request to publish content included in the SMS message on a social networking platform (step 555). In some implementations, the agent receives the SMS message from a consumer device. In some implementations, the agent receives the SMS message from a consumer device associated with an existing or targeted customer of the client for which the agent serves as an agent. In some implementations, the agent can receive the SMS in response to sending an SMS message to one or more consumer devices. In some implementations, the SMS message can be sent to a phone number or short code of the agent. In some implementations, the SMS message has a destination address corresponding to a phone number or short code of a particular client. In some such implementations, the agent can intercept the SMS message.

The SMS message can include an image and instructions corresponding to the image. The instructions can be a text string indicating what to do with the image. In some implementations, the agent can identify a particular social networking platform from the received instructions. In some implementations, the agent can identify a particular client from the received instructions. In some implementations, instructions can include additional information, for example, the instructions can include a title for the image, a description of the image, or a product identifier corresponding to a product shown in the image. The product identifier can correspond to a product of the client for which the agent serves as an agent. For example, the product identifier can include a stock keeping unit (SKU). In some implementations, the instructions can identify a particular URL to which to link the image when the image is published on the social networking platform.

In some implementations, the particular URL can point to a webpage of the client at which the product can be purchased. In some implementations, the particular URL can point to a webpage to which the consumer of the consumer device wishes to direct users. In some implementations, the URL can point to a webpage where the product can be purchased, where the product is reviewed, amongst others. In some implementations, the URL can be based on the type of image provided. If the image is of a cake, the URL can point to a webpage where the recipe for the cake is provided. In some implementations, the agent can be configured to automatically determine an appropriate or suitable webpage to associate to the image. In some implementations, the agent can be configured to provide, to the consumer, one or more options of webpages

In some implementations, the agent can receive various types of requests to publish content instead of SMS messages. For example, the agent can receive a request from a user via a web browser of the consumer device. In some implementations, the agent can receive a request through a native application of the agent operating on the consumer device. In some implementations, such requests can identify a particular client for which a consumer using the consumer device desires to provide the content included in the request.

In some implementations, the agent then identifies a client with which to associate the received SMS message and a social networking platform on which to publish the content (step 560). In some implementations, the agent can identify a client to which the SMS message corresponds based on the phone number or short code to which the SMS message was sent. In some implementations, the agent can identify a client to which the SMS message corresponds based on information included within the SMS message. In some implementations, the SMS message can identify the client based on one or more keywords included in the SMS message. In addition, the agent can identify a social networking platform on which to publish the content. In some implementations, the identity of the social networking platform can be determined from the contents of the SMS message, for example, the keyword included in the SMS message. In some implementations, the agent can determine the identity of the social networking platform based on one or more policies. For example, a client can maintain a policy for publishing SMS content received from a consumer device to a particular social networking platform. As described above, an example of a keyword can be “Qpin.” The keyword can indicate to the agent receiving the SMS message that the content included in the SMS message is to be published on Pinterest for a client corresponding to the letter Q. In some implementations, the agent can associate the letter Q with a client, for example, QVC. In another example, the keyword can be “Qface,” which can indicate to the agent that the photo is to be published to Facebook for the client QVC. In another example, the keyword can be “Pradapin,” which can indicate to the agent that the photo is to be published to Pinterest for the client Prada. In some implementations, the SMS sender may be made aware of the keyword to insert for uploading content through some other external channel. In some implementations, the keyword can be a collection of characters, which the agent can decipher to identify the client with which to associate the SMS, the social networking platform on which to publish the content, amongst others.

The agent then uploads the content to a webpage configurable by the agent (step 565). In some implementations, the content item can be an image, a multimedia file, a video file, an audio file, a document, or any other type of content item that the consumer device wishes to publish on one or more social networking platforms. In some implementations, the content item is an image and the image is uploaded to a webpage created by the agent. In some implementations, the image is uploaded to an existing webpage of the agent. In some implementations, the image is uploaded to a webpage that is created responsive to receiving the SMS message. In some implementations, the webpage is hosted by a web server of the agent. In some implementations, the webpage is hosted by a web server of the client for which the agent is serving as the agent.

In some implementations, the agent can modify the content included in the received SMS message prior to uploading the content to the webpage. In some implementations in which the content is an image, the agent can insert a watermark on the image. In some implementations, the agent can insert a watermark associated with the client with which the agent is serving as an agent on the image. In some implementations, the agent can modify the image or other content included in the SMS message to include a reference of the client to the content.

In some implementations, the agent can identify a product associated with content to be uploaded on the webpage. In some implementations, the agent can identify a webpage related to the content to be uploaded on the webpage. In one example in which the content is an image, the agent can identify a webpage of the client for which the agent is serving as an agent that is related to an item shown in the image. In some implementations, the agent may identify a client webpage that is related to an item shown in the image based on inspecting or analyzing the image itself or from the SMS message received from the consumer device. In some implementations, the agent may associate the identified webpage of the client to the webpage on which the content is to be uploaded. In one example, the agent can redirect traffic from the webpage on which the content is to be uploaded to the identified client webpage. In some such implementations, the agent may do so in response to the image uploaded on the webpage being published on a social networking platform. In some implementations, the agent can identify a suitable webpage to associate to the content based on the content. For example, if the content is an image of a tennis racket, the agent can identify a webpage where the tennis racket shown in the image can be purchased.

The agent facilitates publishing the content on the identified social networking platform (step 570). In some implementations, the agent can be configured to publish the image uploaded to the webpage to the social networking platform identified by the client device in step 560. Examples of social networking platforms can include, but are not limited to Facebook, Twitter, Pinterest, LinkedIn, Google+, amongst others. In some implementations, the agent can automatically establish a connection with the social networking platform in response to uploading the content to a webpage of the agent. In some implementations, the webpage of the agent may include a social networking icon corresponding to the social networking platform on which to publish the content. In some implementations, the agent can utilize one or more scripts, instructions, programs, or applications to send a request to the social networking platform to publish the uploaded content. In some implementations, the agent can send an API call to the social networking platform to publish the content included in the content package to the social networking platform.

In some implementations, the agent provides, to the consumer device from which the SMS message was received, a link to the webpage on which the content is uploaded. The consumer device can be directed to the webpage on which the content is uploaded. The webpage can include a social networking icon for publishing the uploaded content to the social networking platform. Through the icon, a consumer of the consumer device can access a webpage corresponding to the social networking platform through which the consumer can publish the image. In some implementations, the consumer can provide additional information regarding the content via the webpage corresponding to the social networking platform. In some implementations, the additional information can be specific to a particular social networking platform. For example, if the social networking platform is Pinterest, the user can include selecting a board to which to pin the image, tagging the image, and providing a description or caption of the image.

Once the content is published on the social networking platform, one or more visitors for the social networking platform can access the published content. In some implementations, the published content can be associated with the webpage of the agent on which the content was uploaded. In order to drive traffic to a particular webpage associated with the uploaded content, for example, a webpage of the client associated with the SMS message that included the uploaded content, the agent can be configured to modify the webpage on which the content was uploaded such that all traffic directed to this webpage is routed to the webpage of the client. In some implementations, the webpage associated with the published content can be a webpage through which the visitors can make a purchase, sign up to a mailing list, or take some other action that corresponds to a conversion that is defined by the client.

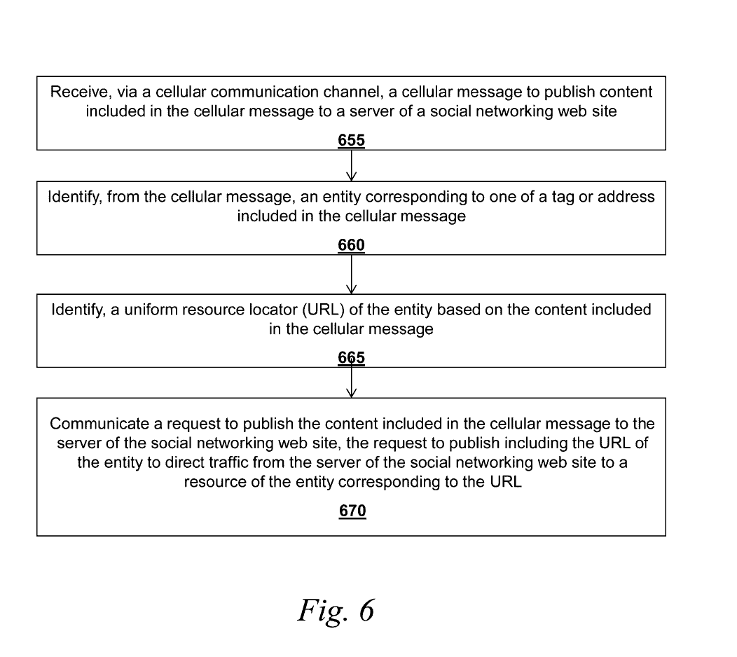

FIG. 6 is a block diagram illustrating a flow of a method for publishing content received via a cellular message to a server of a social networking web site. In brief overview, an agent executing on a device including one or more processors and configured with a network interface to communicate via a cellular network receives a cellular message to publish content included in the cellular message to a server of a social networking web site (step 655). The agent identifies, from the cellular message, an entity corresponding to one of a tag or address included in the cellular message (step 660). The agent identifies a uniform resource locator (URL) of the entity based on the content included in the cellular message (step 665). The agent communicates a request to publish the content included in the cellular message to the server of the social networking web site (step 670).

In further detail, the agent receives a cellular message to publish content included in the cellular message to a server of a social networking web site (step 655). In some implementations, the agent receives the SMS message from a consumer device. In some implementations, the agent receives the SMS message from a consumer device associated with an existing or targeted customer of an entity for which the agent serves as an agent. In some implementations, the agent can receive the SMS in response to sending an SMS message to one or more consumer devices. In some implementations, the SMS message can be sent to a phone number or short code of the agent. In some implementations, the SMS message has a destination address corresponding to a phone number or short code of a particular client. In some such implementations, the agent can intercept or otherwise receive the SMS message before the SMS message is received by the client.

The SMS message can include multimedia content, such as an image, and instructions corresponding to the image. The instructions can be a text string indicating what to do with the image. In some implementations, the agent can identify a particular social networking platform from the received instructions. In some implementations, the agent can identify a particular client from the received instructions. In some implementations, the instructions can include additional information, for example, the instructions can include a title for the image, a description of the image, or a product identifier corresponding to a product shown in the image. The product identifier can correspond to a product of the client for which the client agent serves as an agent. For example, the product identifier can include a stock keeping unit (SKU). In some implementations, the instructions can identify a particular URL to which to link the image when the image is published on the social networking platform.

In some implementations, the particular URL can point to a webpage of the client at which the product can be purchased. In some implementations, the particular URL can point to a webpage to which the consumer of the consumer device wishes to direct users. In some implementations, the URL can point to a webpage where the product can be purchased, where the product is reviewed, amongst others. In some implementations, the URL can be based on the type of image provided. If the image is of a cake, the URL can point to a webpage where the recipe for the cake is provided. In some implementations, the client agent can be configured to automatically determine an appropriate or suitable webpage to associate to the image.

In some implementations, the agent can receive various types of requests to publish content instead of SMS messages. For example, the client agent can receive a request from a user via a web browser of the consumer device. In some implementations, the client agent can receive a request through a native application of the client agent operating on the consumer device. In some implementations, such requests can identify a particular client for which a consumer using the consumer device desires to provide the content included in the request.

The agent identifies, from the cellular message, an entity corresponding to one of a tag or address included in the cellular message (step 660). In some implementations, the agent can identify a client to which the cellular message corresponds based on an address to which the cellular message was sent. The address of the cellular message can be a phone number or short code to which the cellular message was sent. In some implementations, the agent can identify a client to which the cellular message corresponds based on information included within the cellular message. In some implementations, the cellular message can identify the client based on one or more tags or keywords included in the cellular message. In addition, the agent can identify a server of a social networking web site to which to publish the content. In some implementations, the identity of the social networking web site can be determined from the contents of the cellular message, for example, one or more tags included in the cellular message.

In some implementations, the tag includes a predetermined set of characters, a subset of the set of characters are unique to the entity. The agent can identify the entity based on the subset of characters. As described above, an example of a tag or keyword can be “Qpin.” The keyword can indicate to the agent receiving the cellular message that the content included in the cellular message is to be published on Pinterest for a client corresponding to the letter Q. In some implementations, the agent can associate the letter Q with a client, for example, QVC. In another example, the keyword can be “Qface,” which can indicate to the agent that the photo is to be published to Facebook for the client QVC. In another example, the keyword can be “Pradapin,” which can indicate to the agent that the photo is to be published to Pinterest for the client Prada. In some implementations, the message sender may be made aware of the keyword to insert for uploading content through some other external channel. In some implementations, the keyword can be a collection of characters, which the agent can decipher to identify the client with which to associate the cellular message, the social networking web site to which to publish the content, amongst others.

In some implementations, the agent can determine the identity of the social networking web site based on one or more policies. For example, a client can maintain a policy for publishing content included in a cellular message received from a consumer device to a particular social networking web site.

In some implementations, the agent may upload the content included in the cellular message to a webpage configurable by the agent. In some implementations, the content item can be an image, a multimedia file, a video file, an audio file, a document, or any other type of content item that the consumer device wishes to publish to one or more social networking web sites. In some implementations, the content is an image and the image is uploaded to a resource or webpage created by the agent. In some implementations, the image is uploaded to an existing webpage of the agent. In some implementations, the image is uploaded to a webpage that is created responsive to receiving the SMS message. In some implementations, the webpage is hosted by a web server of the agent. In some implementations, the webpage is hosted by a web server of the client for which the agent is serving as the agent.

In some implementations, the agent can modify the content included in the received SMS message prior to uploading the content to the webpage. In some implementations in which the content is an image, the agent can insert a watermark on the image. In some implementations, the agent can insert a watermark associated with the client with which the agent is serving as an agent on the image. In some implementations, the agent can modify the image or other content included in the SMS message to include a reference of the client to the content.

In some implementations, the agent can identify a product associated with content to be uploaded on the webpage. In some implementations, the agent can identify a webpage related to the content to be uploaded on the webpage. In one example in which the content is an image, the agent can identify a webpage of the client for which the agent is serving as an agent that is related to an item shown in the image. In some implementations, the agent may identify a client webpage that is related to an item shown in the image based on inspecting or analyzing the image itself and comparing it to stored profiles of products or from the SMS message received from the consumer device.

The agent identifies a uniform resource locator (URL) of the entity based on the content included in the cellular message (step 665). The URL of the entity corresponds to a resource of the entity to which to direct traffic. As the content is to be published to a server of a social networking web site, traffic generated by the published content can be routed or redirected to the resource of the entity that corresponds to the URL of the entity. In some implementations, the agent identifies the URL of the entity based on a product identified in the content. In some implementations, the agent identifies the URL based on information included in the cellular message that identifies a product or service with which to associate the content. In some implementations, the URL can be identified by performing a lookup of a keyword included in the message in a database of the client identified from the cellular message.

In some implementations, the agent may associate or map the identified webpage of the client to the webpage on which the content is to be uploaded. In one example, the agent can redirect traffic from the webpage on which the content is to be uploaded to the identified client webpage. In some such implementations, the agent may do so in response to the image uploaded on the webpage being published on a social networking platform. In some implementations, the agent can identify a suitable webpage to associate to the content based on the content. For example, if the content is an image of a tennis racket, the agent can identify a webpage where the tennis racket shown in the image can be purchased.

The agent communicates a request to publish the content included in the cellular message to the server of the social networking web site (step 670). The request to publish includes the URL of the entity to direct traffic from the server of the social networking web site to a resource of the entity corresponding to the URL. Examples of social networking web sites can include, but are not limited to Facebook, Twitter, Pinterest, LinkedIn, Google+, Instagram, amongst others. In some implementations, the agent can automatically establish a connection with a server of the social networking web site in response to uploading the content to a webpage of the agent. In some implementations, the webpage of the agent may include a social networking icon corresponding to the social networking web site to which to publish the content. In some implementations, the agent can utilize one or more scripts, instructions, programs, or applications to send a request to the social networking web site to publish the uploaded content. In some implementations, the agent can send an API call to the social networking platform to publish the content included in the content package to the social networking platform.

In some implementations, the agent provides, to the consumer device from which the SMS message was received, a link to the webpage on which the content is uploaded. The consumer device can be directed to the webpage on which the content is uploaded. The webpage can include a social networking icon for publishing the uploaded content to the social networking platform. Through the icon, a consumer of the consumer device can access a webpage corresponding to the social networking web site through which the consumer can publish the image. In some implementations, the consumer can provide additional information regarding the content via the webpage corresponding to the social networking platform. In some implementations, the additional information can be specific to a particular social networking web site For example, if the social networking platform is Pinterest, the user can include selecting a board to which to pin the image, tagging the image, and providing a description or caption of the image. In some implementations, the agent can include the URL of the resource of the client to which to redirect traffic from the published content. In some implementations, the URL can be embedded within the published content such that when a user clicks on the published content, the user is directed to the resource of the client. In some implementations, the URL can be included in a description portion of a resource of the social networking web site on which the published content is published.

Once the content is published on the social networking platform, one or more visitors for the social networking platform can access the published content. In some implementations, the published content can be associated with the webpage of the agent on which the content was uploaded. In order to drive traffic to a particular webpage associated with the uploaded content, for example, a webpage of the client associated with the SMS message that included the uploaded content, the agent can be configured to modify the webpage on which the content was uploaded such that all traffic directed to this webpage is routed to the webpage of the client. In some implementations, the webpage associated with the published content can be a webpage through which the visitors can make a purchase, sign up to a mailing list, or take some other action that corresponds to a conversion that is defined by the client.

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

1. A method for publishing content received via a cellular message to a server of a social networking web site, the method comprising:
receiving, by an agent executing on a device including one or more processors and configured with a network interface to communicate via a cellular network, via a cellular communication channel, a cellular message to publish content included in the cellular message to a server of a social networking web site;
identifying, by the agent, from the cellular message, an entity corresponding to one of a tag or address included in the cellular message;
identifying, by the agent, a uniform resource locator (URL) of the entity based on the content included in the cellular message; and
communicating, by the agent, a request to publish the content included in the cellular message to the server of the social networking web site, the request to publish including the URL of the entity to direct traffic from the server of the social networking web site to a resource of the entity corresponding to the URL.

2. The method of claim 1, further comprising uploading, by the agent, the content included in the cellular message to the resource of the entity, the resource of the entity configurable by the agent.

3. The method of claim 1, wherein the resource of the entity is a first resource and further comprising:
uploading, by the agent, the content included in the cellular message to a second resource configurable by the agent; and wherein the URL of the entity included in the request includes an address of the second resource that is linked to the first resource of the entity.

4. The method of claim 3, further comprising creating the second resource to which the content is uploaded responsive to receiving the cellular message.

5. The method of claim 1, further comprising:
identifying, by the agent, an address of a resource of the social networking web site to which the content is published;
transmitting, by the agent, via the cellular communication channel, to a cellular device that transmitted the cellular message, the address of the resource of the social networking web site.

6. The method of claim 1, wherein the cellular message includes an image and instructions corresponding to the image.

7. The method of claim 6, wherein the instructions include a title of the image, a description of the image, or a product identifier corresponding to a product shown in the image.

8. The method of claim 1, wherein the tag includes a predetermined set of characters, a subset of the set of characters unique to the entity; and wherein identifying, by the agent, from the cellular message, the entity includes identifying the entity based on the subset of characters.

9. The method of claim 1, further comprising modifying, by the agent, the content included in the cellular message prior to communicating the request to publish the content to the server of the social networking web site.

10. The method of claim 1, further comprising identifying, by the agent, a product identified by the content included in the cellular message and identifying a resource of the entity identified by the cellular message that corresponds to the product.

11. A system for publishing content received via a cellular message to a server of a social networking web site, the system comprising:
an agent executing on a device including one or more processors and configured with a network interface to communicate via a cellular network, the agent including
a message manager configured to
receive, via a cellular communication channel, a cellular message to publish content included in the cellular message to a server of a social networking web site;
identify, from the cellular message, an entity corresponding to one of a tag or address included in the cellular message; and
a content configuration manager configured to
identify, a uniform resource locator (URL) of the entity based on the content included in the cellular message; and
communicate a request to publish the content included in the cellular message to the server of the social networking web site, the request to publish including the URL of the entity to direct traffic from the server of the social networking web site to a resource of the entity corresponding to the URL.

12. The system of claim 11, wherein the content configuration manager is further configured to upload the content included in the cellular message to the resource of the entity, the resource of the entity configurable by the agent.

13. The system of claim 11, wherein the resource of the entity is a first resource and wherein the agent is further configured to upload the content included in the cellular message to a second resource configurable by the agent; and wherein the URL of the entity included in the request includes an address of the second resource that is linked to the first resource of the entity.

14. The system of claim 13, wherein the content configuration manager is further configured create the second resource to which the content is uploaded responsive to receiving the cellular message.

15. The system of claim 11, wherein the content configuration manager is further configured to:
identify an address of a resource of the social networking web site to which the content is published;
transmit, via the cellular communication channel, to a cellular device that transmitted the cellular message, the address of the resource of the social networking web site.

16. The system of claim 11, wherein the cellular message includes an image and instructions corresponding to the image.

17. The system of claim 16, wherein the instructions include a title of the image, a description of the image, or a product identifier corresponding to a product shown in the image.

18. The system of claim 11, wherein the tag includes a predetermined set of characters, a subset of the set of characters unique to the entity; and wherein identifying, by the agent, from the cellular message, the entity includes identifying the entity based on the subset of characters.

19. The system of claim 11, wherein the content configuration manager is further configured to modify the content included in the cellular message prior to communicating the request to publish the content to the server of the social networking web site.

20. The system of claim 11, wherein the content configuration manager is further configured to identify a product identified by the content included in the cellular message and identifying a resource of the entity identified by the cellular message that corresponds to the product.
